(19) United States
(12) Patent Application Publication
(10) Pub. No.: US 2025/0101209 A1
(43) Pub. Date: Mar. 27, 2025

(54) RESIN COMPOSITION, MOLDED BODY, LAMINATE AND LAMINATED TUBE

(71) Applicant: MITSUI CHEMICALS, INC., Chuo-ku, Tokyo (JP)

(72) Inventors: Takashi YAMASAKI, Chiba-shi, Chiba (JP); Akane SHIMANUKI, Ichihara-shi, Chiba (JP); Yuhei IZAIKE, Ichihara-shi, Chiba (JP); Yoshiyuki OGAWA, Chiba-shi, Chiba (JP); Takanori SASAKI, Narashino-shi, Chiba (JP)

(73) Assignee: MITSUI CHEMICALS, INC., Chuo-ku,Tokyo (JP)

(21) Appl. No.: 18/729,990

(22) PCT Filed: Mar. 24, 2023
(86) PCT No.: PCT/JP2023/011759

§ 371 Date: Jul. 18, 2024

(30) Foreign Application Priority Data
Mar. 28, 2022 (JP) 2022-051244

(51) Int. Cl. C08L 23/06; B32B 1/08; B32B 27/08; B32B 27/30; B32B 27/32

(52) U.S. Cl. CPC C08L 23/06; B32B 1/08; B32B 27/08; B32B 27/306; B32B 27/32; B32B 2250/03; B32B 2250/246; B32B 2307/31; B32B 2307/748; B32B 2597/00; C08L 2201/06; C08L 2207/066

(57) ABSTRACT

A resin composition containing 40 to 90 mass % of a biomass-derived polyolefin (A) obtained by polymerizing a monomer component mainly containing a biomass-derived ethylene (x), 25 to 50 mass % of a linear low-density polyethylene (B) having a density of 0.90 to 0.93 g/cm³ and 1 to 10 mass % of a modified polyolefin (C) (provided that a sum of the (A), the (B) and the (C) is 100 mass %), in which a biomass content P_{bio} of the polyolefin (A) is 90% or more, and a biomass content P_{bio} of the resin composition is 50% or more, a formed body containing the same, a multilayer body, and a multilayer tube including the same.

P_{bio}(%)=pMC/105.5×100

(in the equation, pMC indicates the content of radiocarbon ¹⁴C in the polyolefin (A) or the resin composition that is obtained in accordance with ASTM D6866.)

### TECHNICAL FIELD

The present disclosure relates to a resin composition, a formed body, a multilayer body and a multilayer tube.

### BACKGROUND ART

In recent years, due to the growing awareness of the prevention of global warming and the reduction of the amount of petroleum, which is an exhaustible resource, used, there has been a desire of replacing conventional plastic materials derived from fossil fuels by carbon-neutral plastic materials derived from plants, and the use of biomass has been gaining attention.

Biomass is an organic compound photosynthesized from carbon dioxide and water and is a so-called carbon-neutral renewable energy that turns into carbon dioxide and water again when used. Nowadays, a rapid progress has been made in putting biomass plastic produced from biomass as a raw material into practical use, and an attempt to produce a variety of resins from a biomass raw material has been also made.

As biomass-derived resins, Braskem S.A. has begun to produce and sell high-pressure low-density polyethylene (LDPE), linear low-density polyethylene (LLDPE) and high-density polyethylene (HDPE) in 2011. Studies are underway to replace conventional polyethylene derived from fossil fuels using such LDPE, LLDPE and HDPE derived from biomass (for example, refer to Patent Literature 1 and 2).

### CITATION LIST

### Patent Documents

[Patent Literature 1] JP2012-167172A
[Patent Literature 2] JP2013-091259A

### SUMMARY OF INVENTION

### Technical Problem

From latest studies, it was found that resin compositions containing a polyolefin for which a biomass-derived ethylene is used (for example, biomass-derived LDPE, LLDPE or HDPE) tend to have a lower heat sealing strength than resin compositions containing a polyolefin for which a conventional ethylene derived from a fossil fuel is used. In order to improve the heat sealing strength of the resin compositions containing a polyolefin for which a biomass-derived ethylene is used, studies are underway to increase the amount of LLDPE, which is in wide use as a material that improves the heat sealing strength, compounded.

However, since there is a tendency that an excessive increase in the amount of LLDPE compounded makes formability deteriorate, and the realization of a resin composition that contains a polyolefin for which a biomass-derived ethylene is used and is excellent in terms of both the heat sealing strength and the formability is awaited.

An objective that one embodiment of the present disclosure intends to achieve is to provide a resin composition that contains a polyolefin containing a biomass-derived ethylene and is excellent in terms of both the heat sealing strength and formability of a formed body to be obtained. Another objective that one embodiment of the present disclosure intends to achieve is to provide a formed body, a multilayer body and a multilayer tube that contain a polyolefin containing a biomass-derived ethylene and are excellent in terms of both the heat sealing strength and the formability.

### Solution to Problem

As means for achieving the above-described objectives, the following aspects are included.
<1> A resin composition containing:
   40 to 90 mass % of a biomass-derived polyolefin (A) obtained by polymerizing a monomer component mainly containing a biomass-derived ethylene (x);
   25 to 50 mass % of a linear low-density polyethylene (B) having a density of 0.90 to 0.93 g/cm³; and
   1 to 10 mass % of a modified polyolefin (C), provided that a sum of the (A), the (B) and the (C) is 100 mass %,
   wherein a biomass content P_{bio} of the polyolefin (A) calculated by the following method is 90% or more, and
   a biomass content P_{bio} of the resin composition calculated by the following method is 50% or more:
the biomass content P_{bio} is obtained by obtaining a radiocarbon ¹⁴C content pMC in the polyolefin (A) or the resin composition in accordance with ASTM D6866, and assigning the obtained pMC to the following equation:

$${P}_{bio} ( \% ) = pMC / 105.5 \times 100.$$

<2> The resin composition according to <1>, wherein the linear low-density polyethylene (B) contains a biomass-derived linear low-density polyethylene having a biomass content P_{bio} calculated by the following method of 80% or more:
the biomass content P_{bio} is obtained by obtaining a radiocarbon ¹⁴C content pMC in the linear low-density polyethylene (B) in accordance with ASTM D6866, and assigning the obtained pMC to the following equation:

$${P}_{bio} ( \% ) = pMC / 105.5 \times 100.$$

<3> The resin composition according to <1> or <2>, wherein
   a content of the polyolefin (A) is 50 to 75 mass %,
   a content of the linear low-density polyethylene (B) is 25 to 45 mass %, and
   a content of the modified polyolefin (C) is 3 to 7 mass %, provided that the sum of the (A), the (B) and the (C) is 100 mass %.
<4> The resin composition according to any one of <1> to <3>, wherein a density of the polyolefin (A) is 0.91 to 0.96 g/cm³.
<5> A formed body containing the resin composition according to any one of <1> to <4>.
<6> The formed body according to <5>, wherein the formed body is a tube.
<7> A multilayer body including a layer containing the resin composition according to any one of <1> to <4>.
<8> A multilayer tube including the multilayer body according to <7>.

### Advantageous Effects of Invention

According to one embodiment of the present disclosure, it is possible to provide a resin composition that contains a polyolefin containing a biomass-derived ethylene and is excellent in terms of both the heat sealing strength and the formability and a use thereof. According to one embodiment of the present disclosure, a formed body, a multilayer body and a multilayer tube that contain a polyolefin containing a biomass-derived ethylene and are excellent in terms of both the heat sealing strength and the formability are provided.

### DESCRIPTION OF EMBODIMENTS

In the present disclosure, expressions “XX or more and YY or less” and “XX to YY”, which express numerical ranges, mean numerical ranges including the lower limit and the upper limit, which are end points, unless particularly otherwise described.

In addition, in a case where numerical ranges are described stepwise, the upper limit and lower limit of each numerical range can be arbitrarily combined together.

Furthermore, an expression “A and/or B” is a concept including all of the case of A, the case of B and the case of both A and B.

In the present specification, a unit shown in any one of before and after “to” that expresses a numerical range means the values before and after “to” have the same unit unless particularly otherwise described.

In the present specification, a combination of two or more preferable aspects is a more preferable aspect.

In the present disclosure, the density is a value that is measured according to a method in accordance with ASTM D1505.

Hereinafter, the present disclosure will be described in detail.

### [Resin Composition]

A resin composition according to the present disclosure contains 40 to 90 mass % of a biomass-derived polyolefin (A) obtained by polymerizing a monomer component mainly containing a biomass-derived ethylene (x), 25 to 50 mass % of a linear low-density polyethylene (B) having a density of 0.90 to 0.93 g/cm³ and 1 to 10 mass % of a modified polyolefin (C) (provided that the sum of the (A), the (B) and the (C) is 100 mass %), a biomass content P_{bio} of the polyolefin (A) calculated by the following method is 90% or more, and a biomass content P_{bio} of the resin composition calculated by the following method is 50% or more.

The biomass content P_{bio} is obtained by obtaining a radiocarbon ¹⁴C content pMC in the polyolefin (A) or the resin composition in accordance with ASTM D6866, and assigning the obtained pMC to the following equation.

$${P}_{bio} ( \% ) = pMC / 105.5 \times 100$$

The resin composition according to the present disclosure has the above-described feature, whereby a molten resin during forming is likely to be stable due to a high melt tension, and the formability is excellent. In addition, the resin strength becomes high, and the heat sealing strength of a formed body to be obtained is excellent.

From the viewpoint of being excellent in terms of both the heat sealing strength and formability of a formed body to be obtained, the biomass content P_{bio} of the resin composition according to the present disclosure calculated by the following method is 50% or more, preferably 55% or more, more preferably 60% or more and still more preferably 70% or more. The upper limit value of the biomass content P_{bio} of the resin composition is not particularly limited, but is preferably 100% or less and more preferably 98% or less.

The “biomass content P_{bio}” (biomass-derived carbon concentration) is a value of the ¹⁴C content obtained by a radiocarbon (¹⁴C) measurement method in accordance with ASTM D6866.

Since carbon dioxide in the atmosphere contains a certain proportion (105.5 pMC) of ¹⁴C, it is known that the ¹⁴C content in a plant that takes in carbon dioxide in the atmosphere and grow, for example, corn, is also approximately 105.5 pMC. In addition, it is also known that fossil fuels rarely contain ¹⁴C.

Therefore, it is possible to calculate the proportion of biomass-derived carbon by measuring the proportion of ¹⁴C in all carbon atoms that are contained in the polyolefin (A) or the resin composition. The biomass content P_{bio} (that is, the content of biomass-derived carbon) in the present disclosure is obtained by obtaining the radiocarbon ¹⁴C content pMC in the polyolefin (A) or the resin composition in accordance with ASTM D6866, and assigning the obtained pMC to the following equation.

pMC is an abbreviation of percent modern carbon.

$${P}_{bio} ( \% ) = pMC / 105.5 \times 100$$

The biomass content P_{bio} of the resin composition according to the present disclosure can be adjusted with the content of a biomass-derived monomer component (for example, the biomass-derived ethylene (x) to be described below) in the resin composition.

Hereinafter, each feature included in the resin composition according to the present disclosure will be described in detail.

### <Biomass-Derived Polyolefin (A)>

The biomass-derived polyolefin (A) (hereinafter, also simply referred to as “polyolefin (A)”) is a polyolefin obtained by polymerizing a monomer component mainly containing a biomass-derived ethylene (x) (hereinafter, also simply referred to as “ethylene (x)”).

The polyolefin (A) may be a homopolymer of the ethylene (x) or may be a copolymer of the ethylene (x) and a different monomer other than the ethylene (x). In addition, the polyolefin (A) may be biodegradable.

“Mainly containing the biomass-derived ethylene (x)” means that, among monomer components that are raw materials of the polyolefin (A), the component having the largest proportion (mass %) is the biomass-derived ethylene (x), and the content of a structural unit derived from the biomass-derived ethylene (x) preferably exceeds 50 mass % and is more preferably 52 mass % or more and still more preferably 55 mass % or more with respect to all structural units of the polyolefin (A). In addition, the upper limit value of the content is not particularly limited and can be set to, for example, 100 mass % or less. Furthermore, the biomass-derived polyolefin (A) may contain a biomass-derived raw material (for example, the ethylene (x)) in at least a part as a raw material or all raw materials may not be biomass-derived raw materials.

The ethylene (x) is preferably, for example, ethylene produced using ethanol extracted and purified from a plant such as corn or sugar cane as a raw material. For the resin composition according to the present disclosure, such a biomass-derived ethylene (x) is used as a raw material monomer, the polyolefin obtained by polymerizing the ethylene (x) is “derived from biomass.” The ethylene component that is contained in the polyolefin (A) is more preferably composed of the biomass-derived ethylene (x) from the viewpoint of maintaining the biomass content (biomass-derived carbon concentration) at a high level.

Examples of the different monomer other than the ethylene (x) include α-olefins derived from a fossil fuel and α-olefins other than the biomass-derived ethylene. Such different monomers may be used singly or two or more thereof may be used.

Examples of α-olefins derived from a fossil fuel or biomass (here, the biomass-derived ethylene is excluded) include α-olefins having 3 to 20 carbon atoms such as butene, hexene and octene. The polyolefin (A) is preferably a copolymer of the biomass-derived ethylene (x) and the α-olefin derived from a fossil fuel.

In addition to what has been described above, the polyolefin (A) also include olefins produced by a biomass balance approach in which plant/animal waste oil is used as a bionaphtha, mixed with a petroleum-derived naphtha and cracked to obtain an olefin. Examples of the olefins produced by the biomass balance approach include, in addition to the biomass-derived ethylene (x), α-olefins such as propylene.

From the viewpoint of excellent formability of a formed body to be obtained, the polyolefin (A) is preferably a homopolymer of the ethylene (x) and more preferably a biomass-derived low-density polyethylene.

From the viewpoint of the formability of a formed body to be obtained, the content of a structural unit derived from the biomass-derived ethylene (x) is 50 mass % to 100 mass, preferably 60 mass % to 99 mass % and more preferably 70 mass to 98 mass % with respect to the total mass (100 mass %) of the resin composition.

The polyolefin (A) may be obtained by synthesis or may be a commercially available product. The polyolefin (A) can be obtained by, for example, the homopolymerization of ethylene by a high-pressure method or the copolymerization of ethylene and an α-olefin comonomer such as butene, hexene or octene using a solid catalyst or a metallocene catalyst. In addition, as the commercially available product of the polyolefin (A), it is also possible to use, for example, commercially available products such as a plant-derived polyethylene from Braskem S.A.

The resin composition may contain two or more biomass-derived polyolefins (A) having different compositions. In the case of containing two or more polyolefins (A), the “density of the polyolefin (A)” refers to a value calculated by weighted average, and the “MFR of the polyolefin (A)” refers to a value calculated by the logarithmic addition law.

### <<Density>>

The density of the polyolefin (A) is not particularly limited, but is preferably 0.91 to 0.96 g/cm³ and more preferably 0.91 g/cm³ to 0.93 g/cm³.

The density of the polyolefin (A) is a value that is measured according to a method in accordance with ASTM D1505.

In a case where the density of the polyolefin (A) is 0.91 g/cm³ or higher, there is an advantage of superior anti-blocking properties. In addition, in a case where the density of the polyolefin (A) is 0.96 g/cm³ or lower, there is an advantage of an excellent impact strength.

The melt flow rate (MFR) of the polyolefin (A) is not particularly limited, but is preferably 0.1 g/10 minutes to 10 g/10 minutes and more preferably 0.3 g/10 minutes to 8 g/10 minutes.

In the present disclosure, the MFR of the polyolefin (A) is a value that is measured under conditions of 190° C. and a load of 2.16 kg in accordance with ASTM D1238. In a case where the MFR of the polyolefin (A) is 0.1 g/10 minutes or more, there is an advantage in that the amount of heat generated from a resin during film production is small. In addition, in a case where the MFR of the polyolefin (A) is 10 g/10 minutes or less, both the heat sealing strength and formability of a formed body to be obtained are excellent.

From the viewpoint of improving the biomass content, the content of the polyolefin (A) is 40 to 90 mass %, preferably 50 to 85 mass %, more preferably 55 to 80 mass % and still more preferably 50 to 75 mass % (provided that the sum of (A), (B) and (C) is 100 mass %).

One polyolefin (A) may be used singly or two or more polyolefins (A) may be jointly used.

A method for polymerizing the polyolefin (A) is not particularly limited, and the polyolefin (A) can be polymerized by a well-known conventional method. The polymerization temperature or the polymerization pressure are preferably adjusted as appropriate depending on the polymerization method or a polymerization device. In addition, the polymerization device is also not particularly limited, and a well-known conventional device can be used.

### <Linear Low-Density Polyethylene (B)>

The resin composition according to the present disclosure contains the linear low-density polyethylene (B) having a density of 0.90 to 0.93 g/cm³ (hereinafter, also simply referred to as “linear low-density polyethylene (B)”). The resin composition contains the above-described specific linear low-density polyethylene (B), whereby the heat sealing strength is improved.

The linear low-density polyethylene (B) may be a copolymer containing ethylene and a small amount of an α-olefin having 3 to 20 carbon atoms such as propylene, 1-butene, 1-hexene or 1-octene.

The density of the linear low-density polyethylene (B) is 0.90 to 0.93 g/cm³ and preferably 0.905 g/cm³ to 0.925 g/cm³. The density is measured according to a method in accordance with ASTM D1505.

The linear low-density polyethylene (B) may be derived from biomass or derived from a fossil fuel. The linear low-density polyethylene (B) preferably contains a biomass-derived linear low-density polyethylene having a biomass content P_{bio} calculated by the following method of 80% or more and more preferably a biomass-derived linear low-density polyethylene having a biomass content P_{bio} of 85% or more. The biomass content P_{bio} in the linear low-density polyethylene (B) is the same meaning as the biomass content P_{bio} in the polyolefin (A).

The biomass content P_{bio} in the linear low-density polyethylene (B) can be obtained by obtaining a radiocarbon ¹⁴C content pMC in the linear low-density polyethylene (B) in accordance with ASTM D6866, and assigning the obtained pMC to the following equation:

$${P}_{bio} ( \% ) = pMC / 105.5 \times 100 ] .$$

In a case where the linear low-density polyethylene (B) contains the biomass-derived linear low-density polyethylene having a biomass content P_{bio} of 80% or more (preferably 85% or more), the content of the biomass-derived linear low-density polyethylene in the linear low-density polyethylene (B) is preferably more than 50 mass % and 100 mass % or less, more preferably 80 to 100 mass % and still more preferably 95 to 100 mass %.

The melt flow rate (MFR) of the linear low-density polyethylene (B) measured in accordance with ASTM D1238 under conditions of 190° C. and a load of 2.16 kg is preferably 0.1 to 5 g/10 minutes and more preferably 0.2 to 3 g/10 minutes.

The content of the linear low-density polyethylene (B) is 25 to 50 mass %, preferably 25 to 45 mass %, more preferably 30 to 45 mass % and still more preferably 30 to 40 mass % (provided that the sum of (A), (B) and (C) is 100 mass %). One kind of the linear low-density polyethylene (B) may be used singly or two or more kinds of the linear low-density polyethylene (B) may be jointly used.

The linear low-density polyethylene (B) can also be produced by any of conventionally well-known methods and can be produced by, for example, a high-pressure method or a low-pressure method in which a titanium-based catalyst, a vanadium-based catalyst or a metallocene catalyst is used. In addition, a commercially available resin can also be used as it is as the linear low-density polyethylene (B).

### <Modified Polyolefin (C)>

The resin composition according to the present disclosure contains the modified polyolefin (C).

The modified polyolefin (C) is a modified polyolefin obtained by modifying at least a part of an unmodified polyolefin and preferably a modified polyolefin obtained by graft modification with at least one compound (y) selected from the group consisting of unsaturated carboxylic acids and derivatives thereof.

### <<Unmodified Polyolefin>>

The unmodified polyolefin is not particularly limited as long as the unmodified polyolefin is a polyolefin obtained by polymerizing a monomer component containing a fossil fuel-derived olefin, but is preferably an ethylene homopolymer or a copolymer of ethylene and an α-olefin having 3 to 20 carbon atoms, more preferably an ethylene homopolymer or a copolymer of ethylene and an α-olefin having 3 to 10 carbon atoms and still more preferably an ethylene homopolymer or a copolymer of ethylene and an α-olefin having 2 to 8 carbon atoms.

One unmodified polyolefin may be used singly or two or more unmodified polyolefins may be jointly used.

Examples of the α-olefin having 3 to 20 carbon atoms include propylene, 1-butene, 1-pentene, 1-hexene, 1-octene, 1-decene and 4-methyl-1-pentene, and these may be used singly or two or more thereof may be used.

The density of the unmodified polyolefin is preferably 0.860 to 0.960 g/cm³, more preferably 0.865 to 0.955 g/cm³ and still more preferably 0.870 to 0.950 g/cm³.

In addition, the melt flow rate (MFR) of the unmodified polyolefin measured based on ASTM D1238 under conditions of 190° C. and a load of 2.16 kg is preferably 0.01 to 100 g/10 minutes, more preferably 0.05 to 50 g/10 minutes and still more preferably 0.1 to 10 g/10 minutes.

When the density and MFR of the unmodified polyolefin are within these ranges, the density and MFR of the modified polyolefin (C) also become substantially the same, which makes the modified polyolefin (C) easy to handle.

A method for producing the unmodified polyolefin is not particularly limited, and the unmodified polyolefin can be produced by any of conventionally well-known methods and can be produced by, for example, a high-pressure method or a low-pressure method in which a titanium-based catalyst, a vanadium-based catalyst or a metallocene catalyst is used. In addition, the unmodified polyolefin may be any of a resin or an elastomer in terms of the form, both an isotactic structure and a syndiotactic structure can be used, and there are no particular limitations on the stereoregularity.

A commercially available resin can also be used as it is as the unmodified polyolefin.

<<Compound (y)>>

Examples of the at least one compound (y) selected from the group consisting of unsaturated carboxylic acids and derivatives thereof, which is used for the graft modification of the unmodified polyolefin, include unsaturated compounds having one or more carboxy groups, unsaturated compounds having one or more anhydrous carboxy groups and derivatives thereof.

Examples of an unsaturated group in the unsaturated compounds include a vinyl group, a vinylene group and an unsaturated cyclic hydrocarbon group. Specific examples of such unsaturated compounds include unsaturated carboxylic acids such as acrylic acid, methacrylic acid, maleic acid, fumaric acid, tetrahydrophthalic acid, itaconic acid, citraconic acid, crotonic acid, isocrotonic acid, norbornene dicarboxylic acid, and bicyclo[2,2,1] hept-2-ene-5,6-dicarboxylic acid, acid anhydrides thereof or derivatives thereof (for example, acid halides, amides, imides and esters).

Specific examples of the compound (y) include malonyl chloride, malenylimide, maleic anhydride, itaconic anhydride, citraconic anhydride, tetrahydrophthalic anhydride, bicyclo[2,2,1] hept-2-ene-5,6-dicarboxylic anhydride, dimethyl maleate, monomethyl maleate, diethyl maleate, diethyl fumarate, dimethyl itaconate, diethyl citraconate, dimethyl tetrahydrophthalate, dimethyl bicyclo[2,2,1] hept-2-ene-5,6-dicarboxylate, hydroxyethyl (meth)acrylate, hydroxypropyl (meth)acrylate, glycidyl (meth)acrylate, aminoethyl methacrylate and aminopropyl methacrylate.

In addition, these components (y) may be used singly or two or more thereof can be used in combination. Among these, as the compound (y), maleic anhydride, (meth)acrylic acid, itaconic anhydride, citraconic anhydride, tetrahydrophthalic anhydride, bicyclo[2,2,1] hept-2-ene-5,6-dicarboxylic anhydride, hydroxyethyl (meth)acrylate, glycidyl methacrylate and aminopropyl methacrylate are preferable, dicarboxylic acid anhydrides such as maleic anhydride, itaconic anhydride, citraconic anhydride, tetrahydrophthalic anhydride and bicyclo[2,2,1] hept-2-ene-5,6-dicarboxylic anhydride are more preferable, and maleic anhydride is particularly preferable.

As a method for introducing the compound (y) into the unmodified polyolefin, a known method can be employed, and examples thereof include a method in which the compound (y) is graft-copolymerized into the main chain of the unmodified polyolefin or a method in which an olefin and the compound (y) are radical-copolymerized together.

In the case of obtaining the modified polyolefin (C) by graft copolymerization, it is preferable to graft-copolymerize the compound (y) and, furthermore, a different ethylenic unsaturated monomer as necessary into the unmodified polyolefin that serves as the graft main chain in the presence of a radical initiator.

A method for grafting the compound (y) to the unmodified polyolefin is not particularly limited, and a conventionally well-known graft polymerization method such as a solution method or a melt kneading method can be employed.

For example, it is possible to employ a method in which the unmodified polyolefin is dissolved in an organic solvent, next, the compound (y) and a radical initiator such as an organic peroxide as necessary are added to the obtained solution and the components are reacted at a temperature of normally 60° C. to 350° C., preferably 80° C. to 190° C. for 0.5 to 15 hours, preferably, one to 10 hours or a method in which the unmodified polyolefin, the compound (y) and a radical initiator such as an organic peroxide as necessary added using, for example, an extruder in the absence of a solvent and the components are reacted at the melting point of the unmodified polyolefin or higher, preferably 120° C. to 350° C. for 0.5 to 10 minutes.

### <<Characteristics of Modified Polyolefin (C)>>

For example, in a case where the compound (y) is at least one compound selected from the group consisting of maleic anhydride and derivatives thereof, the content (graft amount) of a structural unit derived from the compound (y) in the modified polyolefin (C) is preferably 0.01 mass % to 5.0 mass %, more preferably 0.05 mass % to 4.0 mass % and still more preferably 0.1 mass % to 3.0 mass % in terms of the maleic anhydride-derived structural unit. This is also true even in a case where the compound (y) is a different compound.

When the graft amount is above the above-described range, the compound (y) does not become economical, and when the graft amount in the modified polyolefin (C) is below the above-described range, there is a tendency that the adhesive force is weak.

In the modified polyolefin (C), the content rate of an ethylene-derived structural unit in all structural units except the structural unit derived from the compound (y) is preferably 80 mol % to 100 mol %, more preferably 85 mol % to 100 mol % and still more preferably 95 mol % to 100 mol %. It is excellent that the content rate of the ethylene-derived structural unit is within the above-described range from the viewpoint of fabricability.

The melt flow rate (MFR) of the modified polyolefin (C) measured in accordance with ASTM D1238 under conditions of 190° C. and a load of 2.16 kg is preferably 0.01 g/10 minutes to 500 g/10 minutes and more preferably 0.05 g/10 minutes to 100 g/10 minutes.

When the MFR of the modified polyolefin (C) is within the above-described range, the formability is favorable, and the adhesive force is also excellent. In a method where a peel test is performed with, for example, a 100 μm-thick adhesive layer inserted between base materials by heat press molding and the adhesive force is measured, there is a tendency that, at a low MFR, the longer the molecular chain, the higher the adhesive force.

The density of the modified polyolefin (C) is preferably 0.90 to 0.99 g/cm³ and more preferably 0.95 to 0.98 g/cm³.

The content of the modified polyolefin (C) is 1 to 10 mass %, preferably 2 to 8 mass % and more preferably 3 to 7 mass % (provided that the sum of (A), (B) and (C) is 100 mass %).

### [Other Component]

The resin composition according to the present disclosure may further contain a component other than the polyolefin (A), the linear low-density polyethylene (B) and the modified polyolefin (C) (hereinafter, also referred to as “other component”) to an extent that the objective of the present disclosure is not impaired. As the other component, the resin composition may contain an additive such as an antioxidant, a weathering stabilizer, an antistatic agent, an antifogging agent, an anti-blocking agent, a lubricant, a nucleating agent or a pigment or a polymer or rubber other than the polyolefin (A), the linear low-density polyethylene (B) and the modified polyolefin (C) as necessary.

### [Composition of Resin Composition]

From the viewpoint of easily preparing a resin composition having a high biomass content and being excellent in terms of both the heat sealing strength and formability of a formed body to be obtained, in a case where the sum of the components (A), (B) and (C) is 100%, it is preferable that the content of the polyolefin (A) is 50 to 85 mass % (more preferably 55 to 80 mass % and still more preferably 50 to 75 mass %), the content of the linear low-density polyethylene (B) is 25 to 45 mass % (more preferably 30 to 45 mass % and still more preferably 30 to 40 mass %) and the content of the modified polyolefin (C) is 2 to 8 mass % (more preferably 3 to 7 mass %) in the resin composition according to the present disclosure.

From the viewpoint of easily preparing a resin composition having a high biomass content and being excellent in terms of both the heat sealing strength and formability of a formed body to be obtained, in a case where the sum of the components (A), (B) and (C) is 100%, it is preferable that the content of the polyolefin (A) is 50 to 75 mass %, the content of the linear low-density polyethylene (B) is 25 to 45 mass % and the content of the modified polyolefin (C) is 3 to 7 mass % in the resin composition according to the present disclosure.

A method for producing the resin composition according to the present disclosure is not particularly limited, and a variety of well-known methods can be used. As the method for producing the resin composition, the resin composition can be prepared by a method in which the components (A), (B) and (C) and the other component as necessary are dry-blended with a Henschel mixer, a tumbler blender or a V blender, a method in which the components are dry-blended and then melt-kneaded with a single screw extruder, a multi-screw extruder or a Banbury mixer or a method in which the components are stirred and mixed in the presence of a solvent.

### <Formed Body>

A formed body according to the present disclosure contains the above-described resin composition according to the present disclosure. The formed body is not particularly limited, and examples thereof include an extrusion formed product and an injection molded product.

A method for producing the formed body is not particularly limited, it is possible to use, for example, a variety of conventionally well-known production methods, and examples thereof include extrusion forming, compression molding, injection molding, 3D modeling and microwave heating molding. Among such forming methods, extrusion forming is preferable, and a formed body can be suitably produced by extrusion forming.

The shape of the formed body is not particularly limited, a desired shape can be provided depending on the purpose, and examples thereof include a flat plate shape, a film shape, a tube (cylindrical) shape and a bottle shape.

### <Multilayer Body>

A multilayer body of the present disclosure includes a layer containing the resin composition according to the present disclosure (hereinafter, also referred to as “adhesive layer (I)”). The multilayer body includes the layer containing the resin composition and is thus excellent in terms of both the heat sealing strength and the formability. In addition, in the case of including a layer (II) to be described below, the multilayer body is also excellent in terms of adhesiveness to the layer (II).

The multilayer body preferably includes the adhesive layer (I) and, furthermore, the layer (II) containing at least one polymer selected from the group consisting of a polyamide, a saponified ethylene/vinyl acetate copolymer (EVOH) and a polyester, and in this case, the layer (II) and the adhesive layer (I) are preferably layered so as to be in contact with each other.

The polyamide that is contained in the layer (II) is not particularly limited, and examples thereof include nylon 6, nylon 66, nylon 610, nylon 12, nylon 11, MXD nylon, amorphous nylon and copolymerized nylon.

The saponified ethylene/vinyl alcohol copolymer (EVOH) that is contained in the layer (II) is preferably obtained by saponifying an ethylene/vinyl acetate copolymer having an ethylene content rate of preferably 15 to 60 mol % and more preferably 20 to 50 mol %.

The degree of saponification of the saponified ethylene/vinyl alcohol copolymer (EVOH) is preferably 90% to 100% and more preferably 95% to 100%.

The polyester that is contained in the layer (II) is not particularly limited, and examples thereof include polylactic acid, polyethylene terephthalate, polybutylene terephthalate, polyethylene naphthenate and mixtures of these resins or aromatic polyesters, for example, liquid crystal polymers.

From the viewpoint of being excellent in terms of both the heat sealing strength and the formability, the layer (II) is preferably a layer (II) containing the polyamide, the saponified ethylene/vinyl acetate copolymer (EVOH) or the polyester, more preferably a layer (II) containing the polyamide or the saponified ethylene/vinyl acetate copolymer (EVOH) and still more preferably a layer (II) containing the saponified ethylene/vinyl acetate copolymer (EVOH) (EVOH layer (II)).

From the viewpoint of being excellent in terms of the heat sealing strength, in a case where the multilayer body includes the adhesive layer (I) and the EVOH layer (II), the interlayer adhesive strength (peel strength) between the adhesive layer (I) and the EVOH layer (II) in the case of being peeled off at a peeling rate of 300 mm/minute is preferably 1 N/15 mm or more and less than 5 N/15 mm and more preferably 5 N/15 mm or more.

The adhesive strength is obtained by a measurement method to be described in Examples, which will be described below.

From the viewpoint of being excellent in terms of both the heat sealing strength and the formability, the multilayer body preferably further includes a base material layer (III) composed of a polyethylene. In a case where the multilayer body includes the base material layer (III) composed of a polyethylene, the adhesive layer (I) and the base material layer (III) are preferably layered so as to be in contact with each other.

The polyethylene that is contained in the base material layer (III) is not particularly limited, and a well-known polyethylene can be used.

Examples of the layer configuration of the multilayer body according to the present disclosure include a two-layer structure of the layer (II)/the adhesive layer (I), a three-layer structure of the layer (II)/the adhesive layer (I)/the layer (II), a three-layer structure of the base material layer (III)/the adhesive layer (I)/the layer (II), a three-layer structure of the adhesive layer (I)/the layer (II)/the adhesive layer (I) and a five-layer structure of the base material layer (III)/the adhesive layer (I)/the layer (II)/the adhesive layer (I)/the base material layer (III).

Among these, from the viewpoint of being excellent in terms of the barrier properties of the multilayer body, the three-layer structure of the layer (II)/the adhesive layer (I)/the layer (II), the three-layer structure of the base material layer (III)/the adhesive layer (I)/the layer (II) and the three-layer structure of the adhesive layer (I)/the layer (II)/the adhesive layer (I) are preferable, and the three-layer structure of the base material layer (III)/the adhesive layer (I)/the layer (II) is more preferable.

From the viewpoint of being excellent in terms of both the heat sealing strength and the formability, the thickness of the adhesive layer (I) is preferably 10 μm to 100 μm, more preferably 20 μm to 80 μm and still more preferably 30 μm to 60 μm.

From the viewpoint of being excellent in terms of both the heat sealing strength and the formability, in a case where the multilayer body has a three-layer structure, the thickness of the multilayer body is preferably 200 μm to 1000 μm, more preferably 200 μm to 850 μm and still more preferably 200 μm to 500 μm. In a case where the multilayer body has a five-layer structure, the thickness of the multilayer body is preferably 0.1 μm to 50 μm and more preferably 1 μm to 20 μm.

In addition, the multilayer body according to the present disclosure may include a different layer other than the adhesive layer (I), the layer (II) and the base material layer (III) as long as the effect of the present disclosure is not impaired.

Examples of the different layer include a layer composed of a metal such as aluminum, iron, copper, tin or nickel, a layer composed of an alloy containing at least one of these metals as a main component and a regrind layer.

The regrind layer refers to a layer composed of a substance obtained by crushing a burr portion that is generated in the case of forming the multilayer body (unnecessary portion), a recovered product of the multilayer body (scrap) or a defective product that is generated during forming and melt-kneading the crushed product with, for example, an extruder if necessary (regrind). Such a different layer can also be used instead of the base material layer (III).

A well-known additive such as a filler, a stabilizer, a lubricant, an antistatic agent, a flame retardant or a foaming agent may be added, with each of the above-described layers constituting the multilayer body according to the present disclosure to an extent that the objective of the present disclosure is not impaired.

A method for producing the multilayer body according to the present disclosure is not particularly limited, and examples thereof include well-known methods such as coextrusion forming, press molding and extrusion lamination forming. Among these, the coextrusion forming method is preferable as the method for producing the multilayer body from the viewpoint of the interlayer adhesive force.

Examples of the coextrusion forming method include a T-die method in which a flat die is used and an inflation method in which a circular die is used. As the flat die, any of a single manifold form and a multi-manifold form in which a black box is used may be used. The die that is used in the inflation method is not particularly limited, and a well-known die can be used.

### [Use]

The resin composition according to the present disclosure, formed bodies containing the resin composition (for example, a film, a tube and a bottle), multilayer bodies including a layer containing the resin composition, and multilayer films, multilayer tubes and multilayer bottles each including the multilayer body can be suitably used for packaging products such as food containers and bags, containers, sheets and packaging products for cosmetics and containers, sheets and packaging products for pharmaceuticals and, additionally, can be suitably used in a variety of uses such as optical films, resin plates, a variety of label materials, lid materials and laminated tubes.

The multilayer body is particularly preferably a multilayer tube from the viewpoint of being excellent in terms of the heat sealing properties.

### EXAMPLES

Hereinafter, the present disclosure will be more specifically described based on Examples, but the present disclosure is not limited to these Examples.

### [Methods for Measuring Physical Properties]

In Examples and Comparative Examples, physical properties (density, melt flow rate and melt tension) were measured by the following methods.

<Density (g/cm³)>

The density was measured in accordance with ASTM D1505.

<Melt Flow Rate (MFR) (g/10 Minutes)>

The melt flow rate (MFR) was measured in accordance with ASTM D1238 at a temperature of 190° C. under a load of 2160 g.

### [Materials Used]

Polyolefins used in Examples and Comparative Examples will be shown below. As bio LDPE-1, bio LDPE-2 and bio LLDPE-1, commercially available products were used. In addition, LLDPE-1 and MAH-PE-1 were both prepared by performing polymerization according to a normal method.

The biomass content P_{bio} shows a value calculated by the above-described method.

### <Biomass-Derived Polyolefin (A)>

Bio LDPE-1: Biomass-derived low-density polyethylene (manufactured by Braskem S.A., biomass content P_{bio}: 95% (in accordance with ASTM D6866), density: 0.92 g/cm³, MFR: 7.7 g/10 minutes)
Bio LDPE-2: Biomass-derived low-density polyethylene (manufactured by Braskem S.A., biomass content P_{bio}: 95% (in accordance with ASTM D6866), density: 0.92 g/cm³, MFR: 0.3 g/10 minutes)

### <Linear Low-Density Polyethylene (B)>

LLDPE-1: Fossil fuel-derived linear low-density polyethylene (density: 0.90 g/cm³, MFR: 1.3 g/10 minutes).
Bio LLDPE-1: Biomass-derived linear low-density polyethylene (manufactured by Braskem S.A., biomass content P_{bio}: 87% (in accordance with ASTM D6866), density: 0.92 g/cm³, MFR: 0.9 g/10 minutes)

### <Modified Polyolefin (C): Maleic Anhydride-Modified Polyethylene>

MAH-PE-1: Fossil fuel-derived maleic anhydride-modified high-density polyethylene (amount of maleic anhydride grafted: 2.4 mass %, density: 0.97 g/cm³, MFR: 5 g/10 minutes)

### Example 1

### <Preparation of Resin Composition>

A mixture obtained by compounding 40 mass % of the bio LDPE-1 and 25 mass % of the bio LDPE-2 as a biomass-derived polyolefin (A), 30 mass % of the LLDPE-1 as a linear low-density polyethylene (B) and 5 mass % of the MAH-PE-1 as a modified polyolefin (C) was kneaded and granulated with a 65 mmφ single screw extruder set to 220° C., thereby obtaining pellets of a resin composition. As shown in Table 1, the obtained resin composition had a density of 0.92 g/cm³, an MFR of 2.0 g/10 minutes, a melt tension of 26 mN and a biomass content P_{bio} of 65%.

### <Production of Multilayer Body>

A multilayer body (film) composed of three layers layered in this order of a PE (polyethylene) layer (III) made of linear low-density polyethylene (LLDPE) (manufactured by Prime Polymer Co., Ltd., Model No.: ULTZEX 2021L), an adhesive layer (I) made of the above-obtained resin composition and an EVOH layer (II) made of an ethylene/vinyl alcohol copolymer (manufactured by Kuraray Co., Ltd., Model No.: EVAL F101A) was produced under the following forming conditions.

### <<Conditions for Forming Multilayer Body>>

Layer structure: PE layer (III)/adhesive layer (I)/EVOH
layer (II)

| | |
|---|---|
| Thicknesses of layers: | 160 μm |
| PE layer (III) | |
| Adhesive layer (I) | 40 μm |
| EVOH layer (II) | 40 μm |
| T-die forming machine: | 40 mmφ |
| PE layer (III) | extruder, set temperature: 220° C. |
| Adhesive layer (I) | 30 mmφ |
| | extruder, set temperature: 220° C. |
| EVOH layer (II) | 30 mmφ |
| | extruder, set temperature: 220° C. |

Forming rate: 5 m/minute
   <Adhesive Strength (N/15 mm)>

As the adhesive strength of the above-obtained multilayer body (three-layer film), a 15 mm-wide sample was cut out from the multilayer body, and the interlayer adhesive strength (peel strength) between the adhesive layer (I) and the EVOH layer (II) was measured in a constant-temperature bath at 23° C. using a tensile tester (manufactured by Intesco Co., Ltd., Model No.: “IM-20ST”). A measurement method in a peel test was a T-peeling method, and the peeling rate was set to 300 mm/minute. This measurement was performed five times, the average of the obtained numerical values was regarded as the adhesive strength (EVOH adhesive power) of the multilayer body, and the adhesive strength was evaluated with the following evaluation criteria. The results are shown in Table 1.

### (Evaluation Criteria)

A: The adhesive strength is 5 N/15 mm or higher.
B: The adhesive strength is 1 N/15 mm or higher and lower than 5 N/15 mm.
C: The adhesive strength is lower than 1 N/15 mm.

### <Production of Heat Sealing Strength Measurement Sample>

A single-layer film was fabricated using the above-obtained resin composition under the following forming conditions.

### <<Conditions for Forming Single-Layer Film>>

Thickness of layer: 100 μm
T-die forming machine: 30 mmφ extruder, set temperature: 220° C.
Forming rate: 5 m/minute
   <Heat Sealing Strength (N/15 mm)>

Two single-layer films of the resin composition produced above were overlapped together and heat-sealed using a heat sealing machine (manufactured by Tester Sangyo Co., Ltd., Model No.: TP-701-A/B) at 170° C. and a pressure of 0.2 MPa for three seconds, thereby fabricating a heat sealing strength measurement sample.

As the heat sealing strength, a 15 mm-wide sample was cut out from the heat sealing strength measurement sample, and the interlayer adhesive strength (heat sealing strength) between the single-layer films of the resin composition was measured in a constant-temperature bath at 23° C. using the tensile tester (manufactured by Intesco Co., Ltd., Model No.: “IM-20ST”). The peeling rate was set to 300 mm/minute. This measurement was performed five times, the average of the obtained numerical values was regarded as the heat sealing strength (HS strength) of the resin composition and evaluated with the following evaluation criteria. The results are shown in Table 1.

### (Evaluation Criteria)

A: The heat sealing strength is 30 N/15 mm or higher.
B: The heat sealing strength is 25 N/15 mm or higher and lower than 30 N/15 mm. C: The heat sealing strength is lower than 25 N/15 mm.

### <Melt Tension (Formability)>

The melt tension was measured using CAPILOGRAPH 1D manufactured by Toyo Seiki Seisaku-sho, Ltd. The pellets of the resin composition were put into a cylinder having a diameter of 9.55 mm and a length of 350 mm and melted at 230° C. The molten resin was extracted at 15 mm/minute, and a filament come out from a capillary that was installed at the lower portion of the cylinder and had a nozzle diameter of 2.095 mm and a length of 8 mm was coiled at room temperature. Tension when the coiling rate reached 15 m/minute was measured, regarded as the melt tension (unit: mN) and evaluated with the following evaluation criteria. As the value of the melt tension becomes larger, superior formability is exhibited.

### (Evaluation Criteria)

A: The melt tension is 30 mN or more.
B: The melt tension is 20 mN or more and less than 30 mN.
C: The melt tension is less than 20 mN.

### Examples 2 and 3 and Comparative Examples 1 to 3

Resin compositions were prepared by the same method as in Example 1 except that the compounding formulations were changed as shown in Table 1, and the MFRs, densities and melt tensions thereof were measured. Multilayer bodies and single-layer films were produced in the same manner as in Example 1 using the obtained resin compositions, and the adhesive strengths and the heat sealing strengths were measured using the obtained single-layer films. The results are shown in Table 1.

TABLE 1

| | | | | | | Comparative | Comparative | Comparative |
|---|---|---|---|---|---|---|---|---|
| | | | Example 1 | Example 2 | Example 3 | Example 1 | Example 2 | Example 3 |
| Compounding | Biomass-derived | Bio LDPE-1 | 40 | 30 | 40 | 40 | 30 | 15 |
| (mass %) | polyolefin (A) | Bio LDPE-2 | 25 | 25 | 25 | 55 | 45 | 20 |
| | Linear low-density | LLDPE-1 | 30 | 40 | — | — | 20 | 60 |
| | polyethylene (B) | Bio LLDPE-1 | — | — | 30 | — | — | — |
| | Modified polyolefin | MAH-PE-1 | 5 | 5 | 5 | 5 | 5 | 5 |
| | (C) | | | | | | | |
| Physical | MFR | g/10 minutes | 2.0 | 1.7 | 1.8 | 1.3 | 1.2 | 1.4 |
| property | Density | g/cm³ | 0.92 | 0.92 | 0.92 | 0.92 | 0.92 | 0.91 |
| values of | Biomass content | % | 65% | 55% | 91% | 95% | 75% | 35% |
| resin | P_{bio} | | | | | | | |
| composition | | | | | | | | |

| | | | | | | | |
|---|---|---|---|---|---|---|---|
| Evaluation | Adhesive strength (N/15 mm) | B (3.5) | B (4.1) | B (3.6) | B (1.5) | B (2.0) | A (5.7) |
| | HS strength (N/15 mm) | B (28) | A (31) | B (29) | C (16) | C (22) | A (33) |
| | Melt tension (mN) | B (26) | B (27) | B (27) | A (53) | A (37) | C (16) |

In Table 1, “-” means that the corresponding component is not contained.

As shown in Table 1, it is found that the multilayer bodies including a layer made of the resin composition of each of Examples 1 to 3 according to the present disclosure were excellent in terms of the heat sealing strength and the formability compared with the formed bodies made of the resin composition of each of Comparative Examples 1 to 3.

It is found that, in both of Example 1 where the fossil fuel-derived LLDPE was contained and Example 3 where the biomass-derived LLDPE was contained, the heat sealing strength and the formability were excellent compared with Comparative Examples 1 to 3. In addition, it is found that, in Example 2 where 40 mass % of the biomass-derived LLDPE was contained as well, the heat sealing strength and the formability were excellent compared with Comparative Examples 1 to 3. Furthermore, it is found that Example 3 where 30 mass % of the biomass-derived LLDPE was contained had the same or more favorable heat sealing strength and formability as or than Example 1 where 30 mass % of the fossil fuel-derived LLDPE was contained.

1. A resin composition comprising:
40 to 90 mass % of a biomass-derived polyolefin (A) obtained by polymerizing a monomer component mainly containing a biomass-derived ethylene (x);
25 to 50 mass % of a linear low-density polyethylene (B) having a density of 0.90 to 0.93 g/cm³; and
1 to 10 mass % of a modified polyolefin (C), provided that a sum of the (A), the (B) and the (C) is 100 mass %,
wherein a biomass content P_{bio} of the polyolefin (A) calculated by the following method is 90% or more, and
a biomass content P_{bio} of the resin composition calculated by the following method is 50% or more:
the biomass content P_{bio} is obtained by obtaining a radiocarbon ¹⁴C content pMC in the polyolefin (A) or the resin composition in accordance with ASTM D6866, and assigning the obtained pMC to the following equation:
$${P}_{bio} ( \% ) = pMC / 105.5 \times 100.$$

2. The resin composition according to claim 1, wherein the linear low-density polyethylene (B) contains a biomass-derived linear low-density polyethylene having a biomass content P_{bio} calculated by the following method of 80% or more:
the biomass content P_{bio} is obtained by obtaining a radiocarbon 14C content pMC in the linear low-density polyethylene (B) in accordance with ASTM D6866, and assigning the obtained pMC to the following equation:
$${P}_{bio} ( \% ) = pMC / 105.5 \times 100.$$

3. The resin composition according to claim 1, wherein
a content of the polyolefin (A) is 50 to 75 mass %,
a content of the linear low-density polyethylene (B) is 25 to 45 mass %, and
a content of the modified polyolefin (C) is 3 to 7 mass %, provided that the sum of the (A), the (B) and the (C) is 100 mass %.

4. The resin composition according to claim 1, wherein a density of the polyolefin (A) is 0.91 to 0.96 g/cm³.

5. A formed body comprising the resin composition according claim 1.

6. The formed body according to claim 5, wherein the formed body is a tube.

7. A multilayer body comprising a layer containing the resin composition according to claim 1.

8. A multilayer tube comprising the multilayer body according to claim 7.
